(19) United States
(12) Patent Application Publication
(10) Pub. No.: US 2025/0106620 A1
(43) Pub. Date: Mar. 27, 2025

(54) Communications System with Single-Subscriber Device Switching

(71) Applicant: Apple Inc., Cupertino, CA (US)

(72) Inventors: Srinivasan Balasubramanian, San Diego, CA (US); Pankaj Subhash Vasandani, San Jose, CA (US); Lakshmi Iyer, Cupertino, CA (US); Sreevalsan Vallath, Dublin, CA (US)

(21) Appl. No.: 18/807,499

(22) Filed: Aug. 16, 2024

Related U.S. Application Data
(60) Provisional application No. 63/584,273, filed on Sep. 21, 2023.

(51) Int. Cl. H04W 8/26; H04L 67/104; H04W 4/02; H04W 8/18; H04W 36/14; H04W 36/30

(52) U.S. Cl. CPC H04W 8/26; H04L 67/104; H04W 8/18; H04W 36/14; H04W 36/30; H04W 4/023

(57) ABSTRACT

A communications system may include at least a first user equipment (UE) device and a second UE device that communicate with one or more hosts via a cellular network and a call routing server. The first UE and the second UE may be paired and may convey peer-to-peer (P2P) signals between each other when in close proximity. The first UE may communicate with the cellular network using a Mobile Station International Subscriber Directory Number (MSISDN). The MSISDN may, as one example, be shared between the first UE and the second UE. In response to a trigger condition associated with the second UE moving out of proximity to the first UE and/or a user input, communication with the cellular network using the MSISDN may switch from the first UE to the second UE. This may be reversed when the second UE moves back into proximity to the first UE.

This application claims the benefit of U.S. Provisional Patent Application No. 63/584,273, filed Sep. 21, 2023, which is hereby incorporated by reference herein in its entirety

### FIELD

This disclosure relates generally to wireless communications, including wireless communications performed by user equipment devices.

### BACKGROUND

Communications systems can include user equipment devices that convey wireless data with a cellular network. Two or more user equipment devices can be owned by the same user. It can be challenging to coordinate communications between the cellular network and user equipment devices owned by the same user in a cost effective and resource efficient manner.

### SUMMARY

A communications system may include at least a first user equipment (UE) device and a second UE device that communicate with one or more hosts via a cellular network and a call routing server. The first UE device and the second UE device may be paired and may convey peer-to-peer (P2P) signals between each other when in close proximity.

The first UE device may communicate with the cellular network using a Mobile Station International Subscriber Directory Number (MSISDN). The MSISDN may be shared between the first UE device and the second UE device. In response to a trigger condition associated with the second UE device moving out of proximity to the first UE device and/or a user input, communication with the cellular network using the MSISDN may switch from the first UE device to the second UE device. To effectuate the switch, the second UE device may register with the cellular network and the call routing server using the MSISDN. The first UE device may then be deregistered from the cellular network and the call routing server. The second UE device may then communicate with the cellular network using the MSISDN. This process may be reversed when the second UE device moves back into proximity to the first UE device. If desired, the cellular carrier may allow both UE devices to be registered or only one at a time, depending on subscription. This may allow for situations where both a wearable device and a handset are both fully communicable with the cellular network when not in proximity to each other. If desired, these processes may be generalized to any number M credentials, subscriptions, or MSISDNs, as well as N total UE devices (e.g., where M<N).

An aspect of the disclosure provides an electronic device. The electronic device can include one or more antennas. The electronic device can include a subscriber identity module (SIM) that identifies a Mobile Station International Subscriber Directory Number (MSISDN). The electronic device can include a first radio communicably coupled to the one or more antennas, the first radio being configured to convey peer-to-peer (P2P) signals with an additional electronic device that is configured to convey first radio-frequency signals with a cellular network using the MSISDN. The electronic device can include a second radio communicably coupled to the one or more antennas, the second radio being configured to convey, using the MSISDN, second radio-frequency signals with the cellular network while the additional electronic device is deregistered from the cellular network.

An aspect of the disclosure provides a method of operating a first electronic device and a second electronic device to communicate with a cellular network. The method can include conveying, using a first radio on the first electronic device, first wireless data with the cellular network while the second electronic device is in proximity to the first electronic device, the first wireless data being conveyed using a Mobile Station International Subscriber Directory Number (MSISDN). The method can include attaching, using a second radio on the second electronic device, to the cellular network using the MSISDN responsive to a trigger condition associated with the second electronic device moving out of proximity to the first electronic device. The method can include conveying, using the second radio on the second electronic device, second wireless data while attached to the cellular network using the MSISDN.

An aspect of the disclosure provides a method of operating a call routing server. The method can include forwarding, at a first time, first wireless data between one or more hosts and a first user equipment device that is attached to a cellular network using a Mobile Station International Subscriber Directory Number (MSISDN). The method can include registering, at a second time after the first time, a second user equipment device that is attached to the cellular network using the MSISDN. The method can include deregistering the first user equipment device from the MSISDN after registering the second user equipment device. The method can include forwarding, at a third time after the second time, second wireless data between the one or more hosts and the second user equipment device while the second user equipment device attached to the cellular network using the MSISDN and while the first user equipment device is deregistered from the MSISDN.

### BRIEF DESCRIPTION OF THE DRAWINGS

FIG. 1 is a diagram of an illustrative communications system having multiple user equipment devices that share a subscription to a cellular network in accordance with some embodiments.

FIG. 2 is a schematic block diagram of an illustrative user equipment device that shares a subscription to a cellular network with another user equipment device in accordance with some embodiments.

FIG. 3 is a flow chart of illustrative operations involved in performing wireless communications between a cellular network and multiple user equipment devices that share a subscription to the cellular network in accordance with some embodiments.

FIGS. 4 and 5 are timing diagrams showing how signals may be conveyed within a communications system having multiple user equipment devices that share a subscription to a cellular network in accordance with some embodiments.

### DETAILED DESCRIPTION

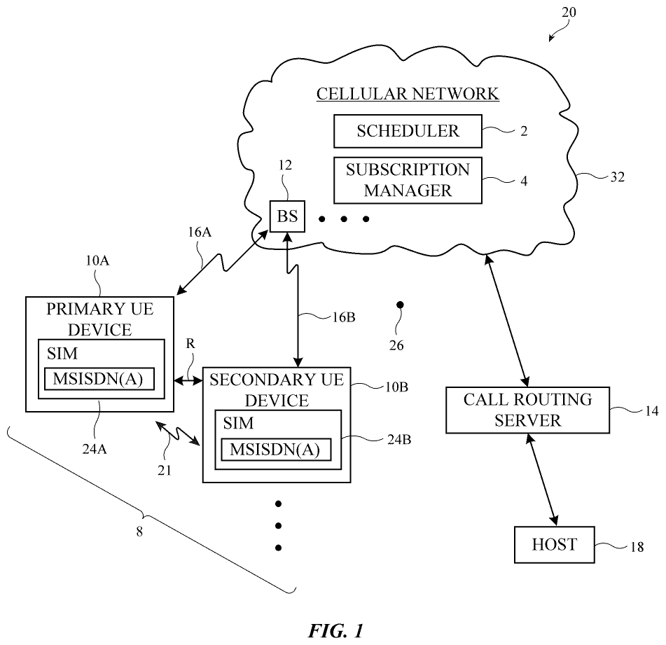

FIG. 1 is a diagram of an illustrative communications system 20. Communications system 20 (sometimes referred to herein as communications network 20, network 20, or system 20) includes user equipment (UE) devices 10 that communicate with a wireless network such as cellular network 22 (e.g., a cellular telephone network). Communications system 20 may also include a call routing server 14 communicably coupled to cellular network 22 over one or more communications paths (links). Communications system 20 may further include one or more hosts 18 communicably coupled to call routing server 14 over one or more communications paths (links).

In general, cellular network 22, call routing server 14, host(s) 18, the communications path(s) that couple call routing server 14 to cellular network 22, and the communications path(s) that couple host(s) 18 to call routing server 14 may include any desired number of network nodes, terminals, and/or end hosts that are communicably coupled together using any desired number of communications paths that include wired and/or wireless links. The wired links may include cables (e.g., ethernet cables, optical fibers or other optical cables that convey signals using light, telephone cables, radio-frequency cables such as coaxial cables or other transmission lines, etc.). The wireless links may include short range wireless communications links that operate over a range of inches, feet, or tens of feet, medium range wireless communications links that operate over a range of hundreds of feet, thousands of feet, miles, or tens of miles, and/or long range wireless communications links that operate over a range of hundreds or thousands of miles. The nodes, terminals, end hosts, and/or communications paths may be organized into and/or distributed across one or more relay networks, mesh networks, local area networks (LANs), wireless local area networks (WLANs), ring networks (e.g., optical rings), cloud networks, virtual/logical networks, the Internet, combinations of these, and/or using any other desired network topologies. The network nodes, terminals, and/or end hosts may include network switches, network routers, optical add-drop multiplexers, other multiplexers, repeaters, modems, portals, gateways, servers, network cards (line cards), wireless access points, wireless base stations, and/or any other desired network components. The network nodes may include physical components such as electronic devices, servers, computers, network racks, line cards, user equipment, etc., and/or may include virtual components that are logically defined in software and that are distributed across (over) two or more underlying physical devices (e.g., in a cloud network configuration).

Cellular network 22 may include one or more wireless base stations such as base station (BS) 12 (e.g., a gNB). UE devices 10 may wirelessly communicate with base station 12 using respective wireless communications links. UE devices 10 may convey wireless radio-frequency signals such as cellular signals 16 with one or more base stations 12 to support the wireless communications link(s). Cellular signals 16 may be conveyed in an uplink (UL) direction from UE device(s) 10 to base station(s) 12 and/or in a downlink (DL) direction from the base station(s) to the UE device(s). If desired, UE device(s) 10 may wirelessly communicate with base station(s) 10 without passing communications through any other intervening network nodes in communications system 20 (e.g., UE device(s) 10 may communicate directly with base station(s) 12 over-the-air). If desired, a UE device 10 may concurrently communicate with multiple base stations 12 of cellular network 22 (e.g., under a carrier aggregation (CA) scheme).

Each base station 12 in cellular network 22 may include one or more antennas. In some implementations, an antenna may include two or more antenna elements arranged in a phased antenna array. The one or more antennas may provide wireless coverage for UE devices located within a corresponding geographic area or region, sometimes referred to as the coverage area, service area, or cell of the corresponding base station. Each base station 12 may have a respective cell in cellular network 22 that covers a corresponding geographic area and each base station 12 may communicate with UE devices located within its cell.

Each cell of cellular network 22 may have any desired shape (e.g., a circular shape, a hexagonal shape, etc.) and may cover any desired area. In general, the size of a cell may correspond to the maximum transmit power level of its base station 12 and the over-the-air attenuation characteristics for radio-frequency signals conveyed by that base station 12, for example. The cells of cellular network 22 may be distributed over one or more geographic regions, areas, or locations such as one or more buildings, campuses, cities, counties, provinces, states, countries, or continents.

When a UE device is located within a given cell, the UE device may connect with the base station 12 of that cell (sometimes referred to herein as attaching to or registering with the base station and cellular network 22). Once the UE device has attached, registered, or connected to the base station and cellular network 22, the UE device may communicate with the base station over a wireless link (e.g., using cellular signals 16). To support the wireless link, base station 12 may transmit cellular signals 16 in the DL direction, sometimes referred to herein as DL signals, and/or the UE device may transmit cellular signals 16 in the UL direction, sometimes referred to herein as UL signals (e.g., the wireless link may be a bidirectional link).

Cellular network 22 may be operated, controlled, serviced, and/or administered by a corresponding cellular network operator or cellular service provider (sometimes also referred to as a mobile network operator (MNO)). Each UE device of cellular network 22 (e.g., UE devices registered with cellular network 22) may, for example, include a subscriber identity module (SIM) 24 (e.g., a SIM card) associated with cellular network 22 and/or the MNO of cellular network 22. Cellular network 22 and the corresponding MNO may sometimes be referred to herein collectively as “the network.”

The cellular network operator may use one or more schedulers such as scheduler 2 to generate, store, maintain, update, and/or implement one or more communications schedules for the UE devices that communicate with the base stations of cellular network 22 (e.g., UE devices registered with cellular network 22). The communications schedule identifies the communications resources (e.g., frequency resources, timing resources, radio access technology (RAT) resources, data modulation/encoding resources, etc.) used to convey wireless data to and/or from each of the UE devices of cellular network 22 (e.g., in a manner that balances traffic loads across the resources of cellular network 22 while minimizing interference between the UE devices). Scheduler 2 may be stored on storage circuitry on one or more base stations 12 and/or other nodes of cellular network 22. Scheduler 2 may be implemented/executed using one or more processors located on one or more base stations 12, on one or more other nodes of cellular network 22, and/or distributed across two or more nodes of cellular network 22.

The SIMS 24 of UE devices 10 may each have or identify a corresponding subscription to the wireless services of cellular network 22. The user who holds the subscription is sometimes referred to as a subscriber. Each subscription may have a corresponding Mobile Station International Subscriber Directory Number (MSISDN) (e.g., representing a globally unique telephone number associated with the subscription). Each SIM 24 may therefore include information identifying its corresponding MSISDN. Cellular network 22 may include a subscription manager 4. Subscription manager 4 may include information identifying all subscribers, subscriptions, and MSISDNs of cellular network 22. Cellular network 20 may use subscription manager 4 to verify the MSISDN of a given UE device to provide that UE device with cellular service.

UE devices 10 may convey wireless data with another node of communications system 20 via base station 12. For example, a UE device 10 may transmit wireless data (e.g., UL data) to base station 12 (using cellular signals 16) for forwarding to an end host communications system 20 such as host 18. Additionally or alternatively, base station 12 may receive wireless data from an end host of communications network 20 (e.g., host 18) for forwarding to UE device 10 (e.g., as DL data in cellular signals 16). Host 18 may, for example, include one or more servers of a content delivery network (CDN) that serves wireless content (e.g., application data, streaming audio data, streaming video data, email messages, text messages, notifications, emergency messages, internet data, image data, operating system data, etc.) to UE devices 10 via cellular network 22. Additionally or alternatively, host 18 may include another UE device 10. In general, host 18 may be any desired source and/or destination of wireless data conveyed by UE devices 10. The wireless data may include streaming video data (e.g., a video call), streaming audio data (e.g., a voice call or audio of a video call), text messages, email messages, Internet data, web browsing data, operating system data, cloud synchronization data, and/or other application data conveyed to and/or from UE device 10 via cellular network 22.

While referred to herein as a “server,” call routing server 14 need not be implemented as a server and may, if desired, be distributed across one or more network nodes of any type (e.g., may be formed from a cloud region of communications system 20). Call routing server 14 may be owned, operated, serviced, and/or administered by a different service provider than the MNO of cellular network 22. Call routing server 14 may, for example, be owned, operated, serviced and/or administered by an entity associated with UE devices 10 such as an entity associated with the operating system, design, and/or manufacture of UE devices 10 and/or one or more applications running on UE devices 10. Call routing server 14 may also include storage circuitry that stores information identifying different subscribers, subscriptions, and MSISDNs of UE devices 10.

Call routing server 14 may use the MSISDNs to forward wireless data between the UE devices 10 associated with call routing server 14 and corresponding host(s) 18. For example, when a given UE device 10 has wireless data for transmission, that UE device may transmit the wireless data to cellular network 22. Cellular network 22 may identify the call routing server 14 to transmit the wireless data based at least in part on the MSISDN of the UE device and/or header/destination information in the wireless data transmitted by the UE device. Cellular network 22 may then forward the wireless data to call routing server 14. Call routing server 14 may forward the wireless data to the corresponding host 18. Conversely, when a host 18 has wireless data for transmission to a particular UE device 10, the host may transmit the wireless data to call routing server 14. Call routing server 14 may identify the particular cellular network 22 to transmit the wireless data based on the MSISDN of the UE device. Call routing server 14 may then forward the wireless data to cellular network 22. Cellular network 22 may identify the particular UE device to transmit the wireless data based on its MSISDN and may forward the wireless data to the appropriate base station 12, which transmits the wireless data to that UE device using cellular signals 16.

While referred to herein as a “call” routing server, call routing server 14 may route any desired wireless data (e.g., voice calls, video calls, streaming video data, streaming audio data, Internet traffic, application data, operating system data, gaming data, cloud computing data, sensor data, control data, emergency broadcast messages, message data such as text messages, email messages, and/or any other desired wireless data) between UE device(s) 10 and corresponding host(s) 18 based on the MSISDN of the UE device(s). Call routing server 14 may sometimes also be referred to as a call routing service, a phone number registration server, a phone number registration service, a phone number synchronization server, or a phone number synchronization service.

In practice, two or more UE devices 10 may be owned and/or operated by the same user. For example, communications system 20 may include a set 8 of UE devices 10 that are owned and/or operated by the same user. Set 8 may include at least a first UE device such as primary UE device 10A and a second UE device such as secondary UE device 10B. Primary UE device 10A is sometimes also referred to herein simply as primary device 10A or primary UE 10A. Secondary UE device 10B is sometimes also referred to herein simply as secondary device 10B or secondary UE 10B. Primary UE 10A and secondary UE 10B may be the same type of device or may be different types of devices. In one implementation that is described herein as an example, primary UE 10A is a cellular telephone and secondary UE 10B is a wearable device such as a wristwatch, a head-mounted display device (e.g., a virtual, augmented, and/or mixed reality device such as glasses, goggles, a helmet, or headset), a gaming controller, a pendant device, a bracelet device, audio headphones (e.g., wireless ear buds or over-the-ear headphones), etc.

Secondary UE 10B may be spatially separated from primary UE 10A by a distance R. When distance R is sufficiently close (e.g., less than a threshold distance), primary UE 10A may transmit wireless data directly to secondary UE 10B and/or secondary UE 10B may transmit wireless data directly to primary UE 10A using peer-to-peer (P2P) signals 21. P2P signals 21 may be conveyed using different frequency bands and/or a different radio access technology (RAT) than cellular signals 16 (e.g., the UE device may convey P2P signals 21 using a first radio and may convey cellular signals using a second radio). P2P signals 21 may, for example, be device-to-device (D2D) signals, cellular sideband signals, Bluetooth signals or other wireless personal area network (WPAN) signals, wireless local area network (WLAN) signals, ultra-low-latency audio signals, etc. If desired, when the P2P signals include WLAN signals, P2P signals 21 may be routed between the primary and secondary UE devices via one or more access points or routers. UE devices 10A and 10B are the end hosts of P2P signals 21 and P2P signals are conveyed between UE devices 10A and 10B without being routed through any intervening network nodes, access points, base stations, etc. When primary UE 10A and secondary UE 10B are able to convey P2P signals 21 with each other, the UE devices are sometimes referred to herein as being paired. The wireless data conveyed by P2P signals 21 may include user input data (e.g., gesture information, touch information, force information, etc. for providing a user input between UE devices), sensor data (e.g., generated by one or more sensors on primary UE 10A and/or secondary UE 10B), application data, message data, video data, image data, audio data, wireless file transfer data, and/or any other desired wireless data.

Both primary UE 10A and secondary UE 10B may have cellular telephone communications capabilities for conveying cellular signals 16 with cellular network 22. For example, if/when primary UE 10A is within range of a base station 12, primary UE 10A may convey wireless data with base station 12 using cellular signals 16A. Similarly, if/when secondary UE 10B is within range of a base station 12, secondary UE 10B may convey wireless data with base station 12 using cellular signals 16B. If desired, when primary UE 10A is paired with secondary UE 10B, primary UE 10A may forward wireless data received from base station 12 in cellular signals 16A to secondary UE 10B using P2P signals 21 and/or may forward wireless data received from secondary UE 10B via P2P signals 21 to base station 12 using cellular signals 16A. Conversely, when primary UE 10A is paired with secondary UE 10B, secondary UE 10B may forward wireless data received from base station 12 in cellular signals 16B to primary UE 10A using P2P signals 21 and/or may convey wireless data received from primary UE 10A via P2P signals 21 to base station 12 using cellular signals 16B.

Situations may arise when secondary UE 10B is not paired or pairable with primary UE 10A but is otherwise within range of a base station 12 of cellular network 22. Such a situation may arise, for example, when secondary UE 10B is located excessively far from primary UE (e.g., when distance R exceeds a threshold distance) but is still within a cell of cellular network 22 (e.g., when secondary UE 10B is at location 26), when primary device 10A is powered down or disabled, when obstacles block P2P signals between primary UE 10A and secondary UE 10B, when the user leaves home with secondary UE 10B but leaves primary UE 10A behind, etc. In these situations, the user may still be able to convey wireless data with host(s) 18 using secondary UE 10B, cellular signals 16B, cellular network 22, and call routing server 14 even though primary UE 10A is no longer co-located with secondary UE 10B.

Primary UE 10A may have a SIM 24A associated with cellular network 22. Secondary UE 10B may have a SIM 24B associated with cellular network 22. In some implementations, primary UE 10A and secondary UE 10B have two different subscriptions to cellular network 22 and thus two different MSISDNs that uniquely identify UE device 10A and UE device 10B for conveying wireless data with cellular network 22 over cellular signals 16A and 16B, respectively. However, requiring primary UE 10A and secondary UE 10B to have two different subscriptions can impose excessive cost on the user of primary UE 10A and secondary UE 10B. Such a cost may, for example, prevent the user from obtaining a secondary UE 10B that has any cellular connectivity.

To mitigate these issues, SIM 24A and SIM 24B may share the same subscription to cellular network 22 and may therefore have the same MSISDN, such as MSISDN (A). Both primary UE 10A and secondary UE 10B may use MSISDN (A) to convey wireless data with host(s) 18 via call routing server 14 and cellular network 22. However, only a single one of primary UE 10A or secondary UE 10B can convey the wireless data with cellular network 22 at any given time, since both UE devices share the same subscription and MSISDN (e.g., because cellular network 22 may only provide services to one device with the subscription at a time, to prevent radio-frequency collisions between the primary UE and the secondary UE, etc.).

Consider an example in which secondary UE 10B is paired with primary UE 10A. In this situation, primary UE 10A may attach or register with cellular network 22 and call routing server 14 using MSISDN (A). At the same time, secondary UE 10B is unattached or unregistered with cellular network 22 and call routing server 14 using MSISDN (A). Since primary UE 10A is registered with cellular network 22 using MSISDN (A), cellular network 22 may transmit paging signals and/or other signals in cellular signals 16A to primary UE 10A without transmitting any paging signals or other signals (e.g., cellular signals 16B) to secondary UE 10B. When primary UE 10A has wireless data to transmit, primary UE 10A may transmit the wireless data to cellular network 22 using cellular signals 16A and MSISDN (A).

Primary UE 10A may generate the wireless data (e.g., based on one or more applications on primary UE 10A, the operating system on primary UE 10A, etc.) or, if desired, may receive the wireless data for transmission from secondary UE 10B via P2P signals 21. Cellular network 22 may forward the wireless data to call routing server 14, which forwards the data to the corresponding destination (host 18). Conversely, a source (host 18) may transmit wireless data to call routing server 14, which forwards the wireless data to cellular network 22 based on MSISDN (A). Cellular network 22 then transmits the wireless data to primary UE 10A using radio-frequency signals 16A and MSISDN (A). If desired, primary UE 10A may forward the wireless data to secondary UE 10B (e.g., to display the wireless data on a display of secondary UE 10B, to forward audio data or call data to secondary UE 10B, etc.).

When secondary UE 10B becomes unpaired with primary UE 10A (e.g., when secondary UE 10B moves to location 26) or in response to any desired trigger condition, the user/subscriber may switch from primary UE 10A to secondary UE 10B for communicating with cellular network 22 using MSISDN (A) (e.g., using the subscription to cellular network 22 shared by primary UE 10A and secondary UE 10B). The switch may involve secondary UE 10B attaching to or registering with cellular network 22 and call routing server 14 using MSISDN (A). Once secondary UE 10B has become attached to cellular network 22 and call routing server 14 using MSISDN (A), primary UE 10A may detach or deregister from cellular network 22 and call routing server 14. Since secondary UE 10B is registered with cellular network 22 using MSISDN (A), cellular network 22 may transmit paging signals and/or other signals in cellular signals 16B to secondary UE 10B without transmitting any paging signals or other signals (e.g., cellular signals 16A) to primary UE 10A.

When secondary UE 10B has wireless data to transmit, secondary UE 10B may transmit the wireless data to cellular network 22 using cellular signals 16B and MSISDN (A). Cellular network 22 may forward the wireless data to call routing server 14 (e.g., based on MSISDN (A)), which forwards the data to the corresponding destination (host 18). Conversely, a source (host 18) may transmit wireless data to call routing server 14, which forwards the wireless data to cellular network 22 based on MSISDN (A). Cellular network 22 then transmits the wireless data to secondary UE 10B using radio-frequency signals 16B (e.g., because secondary UE 10B is registered to cellular network 22 using MSISDN (A) and not primary UE 10A). Once secondary UE 10B has moved within P2P range of primary UE 10A or in response to any desired trigger condition, this process may be reversed to return to using primary UE 10A for communicating with cellular network 22 based on MSISDN (A), while secondary UE 10B is detached from cellular network 22 and call routing server 14. This may be generalized to any desired number of UE devices shared by the same user (e.g., set 8 may include any desired number of UE devices 10) and any desired number of MSISDNs (e.g., two or more MSISDNs) shared by two or more of the UE devices.

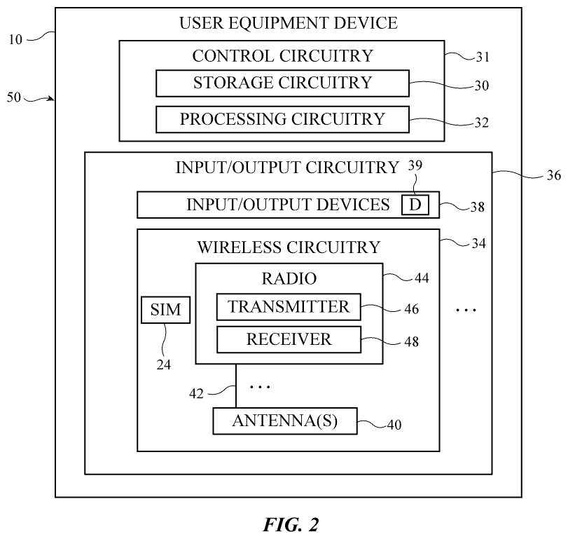

FIG. 2 is a block diagram of an illustrative UE device 10 (e.g., primary UE 10A or secondary UE 10B of FIG. 1). UE device 10 is an electronic device and may therefore sometimes be referred to herein as electronic device 10 or device 10. UE device 10 may be a computing device such as a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses or other equipment worn on a user's head, or other wearable or miniature device, a television, a computer display that does not contain an embedded computer, a gaming device, a navigation device, an embedded system such as a system in which electronic equipment with a display is mounted in a kiosk or automobile, a wireless internet-connected voice-controlled speaker, a home entertainment device, a remote control device, a gaming controller, a peripheral user input device, a wireless base station or access point, equipment that implements the functionality of two or more of these devices, or other electronic equipment.

As shown in FIG. 2, UE device 10 may include components located on or within an electronic device housing such as housing 50. Housing 50, which may sometimes be referred to as a case, may be formed of plastic, glass, ceramics, fiber composites, metal (e.g., stainless steel, aluminum, metal alloys, etc.), other suitable materials, or a combination of these materials. In some situations, part or all of housing 50 may be formed from dielectric or other low-conductivity material (e.g., glass, ceramic, plastic, sapphire, etc.). In other situations, housing 50 or at least some of the structures that make up housing 50 may be formed from metal elements.

UE device 10 may include control circuitry 31. Control circuitry 31 may include storage such as storage circuitry 30. Storage circuitry 30 may include hard disk drive storage, nonvolatile memory (e.g., flash memory or other electrically-programmable-read-only memory configured to form a solid-state drive), volatile memory (e.g., static or dynamic random-access-memory), etc. Storage circuitry 30 may include storage that is integrated within UE device 10 and/or removable storage media.

Control circuitry 31 may include processing circuitry such as processing circuitry 32. Processing circuitry 32 may be used to control the operation of UE device 10. Processing circuitry 32 may include on one or more processors such as microprocessors, microcontrollers, digital signal processors, host processors, baseband processor integrated circuits, application specific integrated circuits, central processing units (CPUs), graphics processing units (GPUs), etc. Control circuitry 31 may be configured to perform operations in UE device 10 using hardware (e.g., dedicated hardware or circuitry), firmware, and/or software. Software code for performing operations in UE device 10 may be stored on storage circuitry 30 (e.g., storage circuitry 30 may include non-transitory (tangible) computer readable storage media that stores the software code). The software code may sometimes be referred to as program instructions, software, data, instructions, or code. Software code stored on storage circuitry 30 may be executed by processing circuitry 32.

Control circuitry 31 may be used to run software on device 10 such as one or more software applications (sometimes referred to herein simply as applications or apps). The applications may be stored at storage circuitry 30. The applications may include satellite navigation applications, internet browsing applications, voice-over-internet-protocol (VOIP) telephone call applications, email applications, media playback applications, operating system functions, gaming applications, productivity applications, workplace applications, augmented reality (AR) applications, extended reality (XR) applications, virtual reality (VR) applications, scheduling applications, consumer applications, social media applications, educational applications, banking applications, spatial ranging applications, sensing applications, security applications, media applications, streaming applications, automotive applications, video editing applications, image editing applications, rendering applications, simulation applications, camera-based applications, imaging applications, news applications, and/or any other desired software applications. The applications may generate and/or receive corresponding wireless data.

To support interactions with external communications equipment, control circuitry 31 may be used in implementing communications protocols. Communications protocols that may be implemented using control circuitry 31 include internet protocols, wireless local area network (WLAN) protocols (e.g., IEEE 802.11 protocols—sometimes referred to as Wi-Fi®), protocols for other short-range wireless communications links such as the Bluetooth® protocol or other wireless personal area network (WPAN) protocols, IEEE 802.11ad protocols (e.g., ultra-wideband protocols), cellular telephone protocols (e.g., 3G protocols, 3^{rd} Generation Partnership Project (3GPP) Fourth Generation (4G) Long Term Evolution (LTE) protocols, 3GPP Fifth Generation (5G) New Radio (NR) protocols, 6G protocols, cellular sideband protocols, etc.), device-to-device (D2D) protocols, antenna diversity protocols, satellite navigation system protocols (e.g., global positioning system (GPS) protocols, global navigation satellite system (GLONASS) protocols, etc.), satellite communications protocols (e.g., for conveying bidirectional data with one or more gateways via one or more communications satellites in a satellite constellation, P2P protocols, antenna-based spatial ranging protocols, or any other desired communications protocols. Each communications protocol may be associated with a corresponding radio access technology (RAT) that specifies the physical connection methodology used in implementing the protocol (e.g., an NR RAT, an LTE RAT, a 3G RAT, a WLAN RAT, etc.). Radio-frequency signals conveyed using a cellular telephone protocol (e.g., radio-frequency signals 16 of FIG. 1) may sometimes be referred to herein as cellular telephone signals.

UE device 10 may include input-output circuitry 36. Input-output circuitry 36 may include input-output devices 38. Input-output devices 38 may be used to allow data to be supplied to UE device 10 and to allow data to be provided from UE device 10 to external devices. Input-output devices 38 may include user interface devices, data port devices, and other input-output components. For example, input-output devices 38 may include touch sensors, displays 39 (e.g., touch-sensitive displays, force-sensitive displays, displays that are not touch sensitive, etc.), light-emitting components, buttons (mechanical buttons, capacitive buttons, optical buttons, etc.), scrolling wheels, touch pads, key pads, keyboards, microphones, cameras, buttons, speakers, status indicators, audio jacks and other audio port components, digital data port devices, motion sensors (accelerometers, gyroscopes, and/or compasses that detect motion), capacitance sensors, proximity sensors, magnetic sensors, force sensors (e.g., force sensors coupled to a display to detect pressure applied to the display), temperature sensors, etc. In some configurations, keyboards, headphones, displays, pointing devices such as trackpads, mice, and joysticks, and other input-output devices may be coupled to UE device 10 using wired or wireless connections (e.g., some of input-output devices 38 may be peripherals that are coupled to a main processing unit or other portion of UE device 10 via a wired or wireless link).

Input-output circuitry 36 may include wireless circuitry 34 to support wireless communications. Wireless circuitry 34 (sometimes referred to herein as wireless communications circuitry 34) may include one or more antennas 40. Wireless circuitry 34 may also include one or more radios 44. Radio 44 may include circuitry that operates on signals at baseband frequencies (e.g., baseband circuitry) and radio-frequency transceiver circuitry such as one or more radio-frequency transmitters 46 and one or more radio-frequency receivers 48. Transmitter 46 may include signal generator circuitry, modulation circuitry, mixer circuitry for upconverting signals from baseband frequencies to intermediate frequencies and/or radio frequencies, amplifier circuitry such as one or more power amplifiers, digital-to-analog converter (DAC) circuitry, control paths, power supply paths, switching circuitry, filter circuitry, and/or any other circuitry for transmitting radio-frequency signals using antenna(s) 40. Receiver 48 may include demodulation circuitry, mixer circuitry for downconverting signals from intermediate frequencies and/or radio frequencies to baseband frequencies, amplifier circuitry (e.g., one or more low-noise amplifiers (LNAs)), analog-to-digital converter (ADC) circuitry, control paths, power supply paths, signal paths, switching circuitry, filter circuitry, and/or any other circuitry for receiving radio-frequency signals using antenna(s) 40. The components of radio 44 may be mounted onto a single substrate or integrated into a single integrated circuit, chip, package, or system-on-chip (SOC) or may be distributed between multiple substrates, integrated circuits, chips, packages, or SOCs.

Wireless circuitry 34 may include one or more SIMs such as SIM 24 (e.g., a SIM card). SIM 24 may be integrated into UE device 10 (e.g., may be an eSIM) or may be a removable SIM card. SIM 24 may store, identify, or otherwise be associated with an MSISDN that is shared with at least one other UE device owned and/or operated by the same user as UE device 10 (e.g., MSISDN (A) of FIG. 1). Radio 44 may use SIM 24 and the MSISDN (A) stored thereon to attach to cellular network 22 and call routing server 14 and to convey cellular signals 16 with cellular network 22 (FIG. 1). Wireless circuitry 34 may, for example, include a first radio 44 that conveys cellular signals and a second radio 44 that conveys P2P signals.

Antenna(s) 40 may be formed using any desired antenna structures for conveying radio-frequency signals. For example, antenna(s) 40 may include antennas with resonating elements that are formed from loop antenna structures, patch antenna structures, inverted-F antenna structures, slot antenna structures, planar inverted-F antenna structures, helical antenna structures, monopole antennas, dipoles, hybrids of these designs, etc. Filter circuitry, switching circuitry, impedance matching circuitry, and/or other antenna tuning components may be adjusted to adjust the frequency response and wireless performance of antenna(s) 40 over time. If desired, two or more of antennas 40 may be integrated into a phased antenna array (sometimes referred to herein as a phased array antenna) in which each of the antennas conveys radio-frequency signals with a respective phase and magnitude that is adjusted over time so the radio-frequency signals constructively and destructively interfere to produce a signal beam in a given/selected beam pointing direction (e.g., towards base station 12 of FIG. 1).

The term “convey radio-frequency signals” as used herein means the transmission and/or reception of the radio-frequency signals (e.g., for performing unidirectional and/or bidirectional wireless communications with external wireless communications equipment). Similarly, the term “convey wireless data” as used herein means the transmission and/or reception of wireless data using radio-frequency signals. Antenna(s) 40 may transmit the radio-frequency signals by radiating the radio-frequency signals into free space (or to free space through intervening device structures such as a dielectric cover layer). Antenna(s) 40 may additionally or alternatively receive the radio-frequency signals from free space (e.g., through intervening devices structures such as a dielectric cover layer). The transmission and reception of radio-frequency signals by antennas 40 each involve the excitation or resonance of antenna currents on an antenna resonating element in the antenna by the radio-frequency signals within the frequency band(s) of operation of the antenna.

Each radio 44 may be coupled to one or more antennas 40 over one or more radio-frequency transmission lines 42. Radio-frequency transmission lines 42 may include coaxial cables, microstrip transmission lines, stripline transmission lines, edge-coupled microstrip transmission lines, edge-coupled stripline transmission lines, transmission lines formed from combinations of transmission lines of these types, etc. Radio-frequency transmission lines 42 may be integrated into rigid and/or flexible printed circuit boards if desired. One or more radio-frequency lines 42 may be shared between multiple radios 44 if desired. Radio-frequency front end (RFFE) modules may be interposed on one or more radio-frequency transmission lines 42. The radio-frequency front end modules may include substrates, integrated circuits, chips, or packages that are separate from radios 44 and may include filter circuitry, switching circuitry, amplifier circuitry, impedance matching circuitry, radio-frequency coupler circuitry, and/or any other desired radio-frequency circuitry for operating on the radio-frequency signals conveyed over radio-frequency transmission lines 42.

Radio 44 may transmit and/or receive radio-frequency signals within corresponding frequency bands at radio frequencies (sometimes referred to herein as communications bands or simply as “bands”). The frequency bands handled by radio 44 may include wireless local area network (WLAN) frequency bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), and/or other Wi-Fi® bands (e.g., from 1875-5160 MHz), wireless personal area network (WPAN) frequency bands such as the 2.4 GHz Bluetooth® band or other WPAN communications bands, cellular telephone frequency bands (e.g., bands from about 600 MHz to about 5 GHz, 3G bands, 4G LTE bands, 5G New Radio Frequency Range 1 (FR1) bands below 10 GHz, 5G New Radio Frequency Range 2 (FR2) bands between 20 and 60 GHZ, cellular sidebands, 6G bands between 100-1000 GHz (e.g., sub-THz, THz, or THF bands), etc.), other centimeter or millimeter wave frequency bands between 10-300 GHz, near-field communications frequency bands (e.g., at 13.56 MHz), satellite navigation frequency bands (e.g., a GPS band from 1565 to 1610 MHz, a Global Navigation Satellite System (GLONASS) band, a BeiDou Navigation Satellite System (BDS) band, etc.), ultra-wideband (UWB) frequency bands that operate under the IEEE 802.15.4 protocol and/or other ultra-wideband communications protocols, communications bands under the family of 3GPP wireless communications standards, communications bands under the IEEE 802.XX family of standards, industrial, scientific, and medical (ISM) bands such as an ISM band between around 900 MHz and 950 MHz or other ISM bands below or above 1 GHz, D2D bands, P2P bands, one or more unlicensed bands, one or more bands reserved for emergency and/or public services, and/or any other desired frequency bands of interest. Wireless circuitry 34 may also be used to perform spatial ranging operations if desired.

The example of FIG. 2 is illustrative and non-limiting. While control circuitry 31 is shown separately from wireless circuitry 34 in the example of FIG. 1 for the sake of clarity, wireless circuitry 34 may include processing circuitry (e.g., one or more processors) that forms a part of processing circuitry 32 and/or storage circuitry that forms a part of storage circuitry 30 of control circuitry 31 (e.g., portions of control circuitry 31 may be implemented on wireless circuitry 34). As an example, control circuitry 31 may include baseband circuitry (e.g., one or more baseband processors), digital control circuitry, analog control circuitry, and/or other control circuitry that forms part of radio 44. The baseband circuitry may, for example, access a communication protocol stack on control circuitry 31 (e.g., storage circuitry 30) to: perform user plane functions at a PHY layer, MAC layer, RLC layer, PDCP layer, SDAP layer, and/or PDU layer, and/or to perform control plane functions at the PHY layer, MAC layer, RLC layer, PDCP layer, RRC, layer, and/or non-access stratum (NAS) layer. If desired, the PHY layer operations may additionally or alternatively be performed by radio-frequency (RF) interface circuitry in wireless circuitry 34. UE device 10′ of FIG. 1 may include one or more (e.g., all) of the components of UE device 10 shown in FIG. 2.

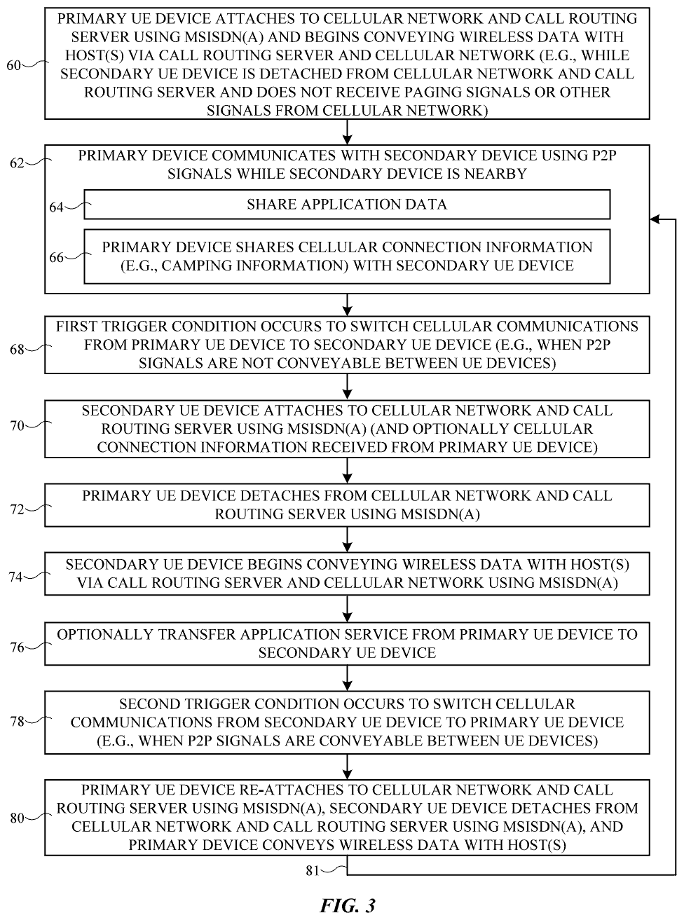

FIG. 3 is a flow chart of illustrative operations involved in using a primary UE 10A and a secondary UE 10B (FIG. 1) that have a single shared subscription to cellular network 22 and thus a single shared MSISDN (A) to communicate via cellular network 22.

At operation 60, primary UE 10A may attach, register, or connect to cellular network 22 for cellular communications service using MSISDN (A). This may, for example, involve uplink and/or downlink transmission of synchronization signals, reference signals, handshake signals, acknowledgement signals, registration signals, attachment signals, and/or other signals in cellular signals 16A conveyed between primary UE 10A and a corresponding base station 12. The network may use subscriber manager 4 to verify and confirm that primary UE 10A has access to the cellular network. Primary UE 10A may enter a connected mode with cellular network 22 after attaching to cellular network 22. Once primary UE 10A has attached to cellular network 22, primary UE 10A may then register with call routing server 14 for call, data, and/or notification routing using MSISDN (A). This may involve, for example, conveying registration signals between primary UE 10A and call routing server 14 using cellular signals 16A and cellular network 22.

Once primary UE 10A has registered to both cellular network 22 and call routing server 14 using MSISDN (A), UE 10A may begin conveying wireless data (e.g., connected mode data) with one or more hosts 18 using cellular signals 16A. Cellular network 22 and call routing server 14 may forward the wireless data between primary UE 10A and host(s) 18. At the same time, secondary UE 10B is not attached or registered to either cellular network 22 or call routing server 14 using MSISDN (A). As such, call routing server 14 and cellular network 22 do not forward wireless data associated with or destined for MSISDN (A) to secondary UE 10B. Secondary UE 10B does not transmit cellular signals 16B to cellular network 22. Cellular network 22 does not transmit paging signals, connected resources, access signals, or other cellular signals 16B to secondary UE 10B, and secondary UE 10B does not receive paging signals, connected resources, access signals, or other cellular signals 16B from cellular network 22. In other words, cellular network 22 only pages one of the two devices having MSISDN (A) at a given time. This may also serve to minimize power and resource consumption on secondary UE 10B.

If desired, at operation 62, primary UE 10A and secondary UE 10B may convey P2P signals 21 with each other (e.g., may be paired when secondary UE 10B is sufficiently close to primary UE 10A). Operation 62 may be performed concurrent with operation 60 if desired. P2P signals 21 may convey any desired wireless data between primary UE 10A and secondary UE 10B. If desired, the wireless data may include wireless data generated by secondary UE 10B and forwarded to a host 18 by primary UE 10A via cellular signals 16A, cellular network 22, and call routing server 14. Additionally or alternatively, the wireless data may include wireless data received by primary UE 10A from a host 18 via call routing server 14, cellular network 22, and cellular signals 16A. Additionally or alternatively, the wireless data in P2P signals 21 may include application data that is shared between one or more applications running on primary UE 10A and/or secondary UE 10B (at operation 64).

If desired, primary UE 10A may use P2P signals 21 to transmit cellular connection information to secondary UE 10B (at operation 66). The cellular connection information may be information about or characterizing the wireless link between primary UE 10A and the corresponding base station 12 of cellular network 22 (e.g., cellular signals 16A). The cellular connection information may include, for example, camping information identifying one or more frequency bands, communications protocols, RATs, timing information, synchronization information, and/or signal beams that primary UE 10A is using or has used to convey cellular signals 16A with cellular network 22. If desired, the camping information may include camping information about the current cell of primary UE 10A, past cells used by primary UE 10A, and/or one or more neighbor cells of the current cell of primary UE 10A. If desired, the cellular connection information may include wireless performance metric data gathered or measured by primary UE 10A based on cellular signals 16A (e.g., received power levels, received signal strength indicator values, signal-to-noise ratio values, error rate values, etc.). The cellular connection information may, for example, be used by secondary UE 10B to connect to cellular network 22 at a later time (e.g., minimizing the time needed for the secondary UE to attach to the cellular network).

At operation 68, a first trigger condition may occur to switch from primary UE 10A to secondary UE 10B for communicating with cellular network 22 using MSISDN (A) (e.g., for switching the device that uses the shared subscription to cellular network 22). The first trigger condition may be an autonomous trigger condition (e.g., may be triggered by the operating system of primary UE 10A and/or secondary UE 10B and/or one or more applications running on primary UE 10A and/or secondary UE 10B without user input) and/or may occur upon or in response to receipt of a user input provided to primary UE 10A and/or secondary UE 10B.

As examples, the first trigger condition may occur if/when secondary UE 10B becomes unpaired with primary UE 10A, if/when secondary UE 10B has moved more than a threshold distance R from primary UE 10A, if/when an object or obstacle has blocked P2P signals 21 between primary UE 10A and secondary UE 10B, if/when radio-frequency propagation or channel conditions between primary UE 10A and secondary UE 10B have dropped below a threshold level, if/when wireless performance metric data gathered by UE 10A and/or UE 10B from P2P signals 21 has dropped below a threshold level (or outside a range of acceptable values), if/when a satellite receiver on secondary UE 10B has identified that secondary UE 10B has left a predetermined location or moved to a predetermined location, if/when sensor data gathered by secondary UE 10B has a particular value (e.g., indicating that UE 10B is no longer pairable with primary UE 10A), if/when sensor data on secondary UE 10B indicates that secondary UE 10B is traveling at a speed exceeding a threshold, if/when it is a particular time of day and/or day of the week, if/when the user has provided a user input (e.g., via the display 39 (FIG. 2) on secondary UE 10B and/or primary UE 10A) that instructs one or more software applications and/or the operating system on one or both devices to perform the switch, if/when sensor data indicates that secondary UE 10B has been picked up or taken away from primary UE 10A, etc.

As another example, when primary UE 10A and/or secondary UE 10B gathers sensor data and/or wireless performance metric data indicative of the user walking away from primary UE 10A with secondary UE 10B, one or more software applications on primary UE 10A and/or secondary UE 10B may issue an alert or notification on the display 39 (FIG. 2) informing the user of the switch and/or requesting that the user provide a user input to confirm the switch. The user may, for example, press an on-screen button, perform a gesture, and/or provide any other desired input to confirm a switch, upon which the UE devices will have determined that the trigger condition has occurred. This may help to ensure that the user actually intends or desires for the switch to occur (e.g., preventing a false or unintended switch). If desired, primary UE 10A and/or secondary UE 10B may perform hysteresis and/or slope detection on the gathered sensor data and/or wireless performance metric data to eliminate false positive triggers (e.g., to prevent the switch from occurring when secondary UE 10B has not actually moved to a location out of P2P range with primary UE 10A). Once the first trigger condition has occurred, processing may proceed to operation 70.

At operation 70, secondary UE 10B may attach, register, or connect to cellular network 22 for cellular service using MSISDN (A). This may, for example, involve uplink and/or downlink transmission of synchronization signals, reference signals, handshake signals, acknowledgement signals, registration signals, attachment signals, and/or other signals in cellular signals 16B conveyed between secondary UE 10B and a corresponding base station 12.

If desired, secondary UE 10B may attach, register, or connect to cellular network 22 based on the cellular connection information (e.g., camping information) received from primary UE 10A via P2P signals 21 while processing operation 66. For example, secondary UE 10B may camp on the resources of cellular network 22 that primary UE 10A previously identified and shared with secondary UE 10B (e.g., for the current cell of primary UE 10A or another cell such as a neighbor cell to the current cell of primary UE 10A) to register with cellular network 22. This may, for example, allow secondary UE 10B to attach to cellular network 22 without having to perform an exhaustive search or system scan procedure over frequency resources, signal beams, etc., thereby minimizing the time required for secondary UE 10B to successfully register with the network.

Secondary UE 10B may enter a connected mode with cellular network 22 after attaching to cellular network 22. Once secondary UE 10B has attached to cellular network 22, secondary UE 10B may then register with call routing server 14 for call, data, and/or notification routing using MSISDN (A). This may involve, for example, conveying registration signals between secondary UE 10B and call routing server 14 using cellular signals 16B and cellular network 22.

At operation 72, primary UE 10A may deregister, detach, or disconnect from call routing server 14 and cellular network 22 using MSISDN (A) (e.g., leaving the connected mode). This may involve, for example, call routing server 14 transmitting a signal that informs primary UE 10A (e.g., via cellular network 22 or another communications path) that secondary UE 10B has taken over the subscription and MSISDN (A) for communicating with cellular network 22 (e.g., after or in response to secondary UE 10B registering with call routing server 14). Additionally or alternatively, cellular network 22 may transmit a detach or deregister signal to primary UE 10A (e.g., in cellular signals 16A) that informs primary UE 10A (e.g., via cellular signals 16A) that secondary UE 10B has taken over the subscription and MSISDN (A) for communicating with cellular network 22 (e.g., after or in response to secondary UE 10B registering with cellular network 22). Additionally or alternatively, cellular network 22 may only convey cellular signals 16 with the UE device that most recently attached or registered with the cellular network using MSISDN (A) (e.g., secondary UE 10B) without informing or synchronizing with the previously-attached UE device (e.g., primary UE 10A). In this situation, it is possible that secondary UE 10B is in a connected state with cellular network 22 during this switch and will be in a transient situation given that primary UE 10A will be detached or deregistered while in that connection. This may, for example, address any race conditions that may arise.

At operation 74, once secondary UE 10B has registered to both cellular network 22 and call routing server 14 using MSISDN (A) and primary UE 10A has detached/deregistered from cellular network 22 and call routing server 14, secondary UE 10B may begin conveying wireless data with one or more hosts 18 using cellular signals 16B. Cellular network 22 and call routing server 14 may forward the wireless data between secondary UE 10B and host(s) 18. At the same time, primary UE 10A is not attached or registered to either cellular network 22 or call routing server 14 using MSISDN (A). As such, call routing server 14 and cellular network 22 do not forward any wireless data associated with or destined for MSISDN (A) to primary UE 10A. Primary UE 10A does not transmit cellular signals 16A to cellular network 22. Cellular network 22 does not transmit paging signals, connected resources, access signals, or other cellular signals 16A to primary UE 10A, and primary UE 10A does not receive paging signals, connected resources, access signals, or other cellular signals 16A from cellular network 22. This may also serve to minimize power and resource consumption on primary UE 10A. P2P signals are not conveyed between primary UE 10A and secondary UE 10B. Alternatively, if within P2P range, the UE devices may continue to convey P2P signals.

At operation 76, call routing server 14 may transfer application service that was being performed for primary UE 10A to secondary UE 10B. This may include, for example, transferring a voice or video call, a streaming audio video, a streaming game, a cloud application service, and/or any other desired application data that was being transmitted and/or received by primary UE 10A using cellular network 22 to secondary UE 10B. Additionally or alternatively, P2P signals 21 may be used to transfer application service upon, prior to, or just after occurrence of the first trigger condition. Additionally or alternatively, another wireless network such as a WLAN network may be used to transfer application service upon, prior to, or just after occurrence of the first trigger condition.

In implementations where secondary UE 10B is a wearable device and primary UE 10A is a cellular telephone, secondary UE 10B may support a subset of the services and/or applications hosted on primary UE 10A. When cellular service under MSISDN (A) is switched to secondary UE 10B, an application may be idle and the context to access via secondary UE 10B may be performed (e.g., for a messaging application). As another example, an application may be active and the context may be transitioned to secondary UE 10B mid-session (e.g., for a voice call). As another example, the application may be either idle or active but not supported by secondary UE 10B. In these situations, the active application is dropped and the idle application is no longer accessible. The application activity may be resumed only when cellular communication under MSISDN (A) is later switched back to primary UE 10A. Any notifications for such applications may be paused during the time when secondary UE 10B performs cellular communication under MSISDN (A). The services that are supported or not supported by secondary UE 10B may depend on user configuration and actions performed may depend on user preferences for application support on secondary UE 10B. For example, a given user may choose for specific applications to be available on secondary UE 10B at different times. This can be enabled per-application or each application can be associated with a priority level and the user may select a priority level when transitioning to secondary UE 10B. In these situations, all applications at the selected priority level or higher may be identified and transitioned to the wearable.

As part of the transition from one UE to the other, active session transfers should also be considered. These may occur, for example, when secondary UE 10B is running out of battery power while on an active voice call or when the user plans to walk away with secondary UE 10B. If desired, a Session Initiation Protocol (SIP) Session Mobility procedure may be performed to effectuate the transition. For example, an IETF RFC support mechanism may be used to handover an active session to a single device (e.g., voice session transfer from cellphone to wearable) or to multiple devices (e.g., voice session to cellphone with video to a projector for larger viewing). Operation 76 may be performed concurrent with operation 72 and/or operation 74 if desired. Operation 76 may be omitted if desired.

At operation 78, a second trigger condition may occur to switch from secondary UE 10B back to primary UE 10A for communicating with cellular network 22 using MSISDN (A) (e.g., for switching the device that uses the shared subscription to cellular network 22). The second trigger condition may be an autonomous trigger condition (e.g., that is triggered by the operating system of primary UE 10A and/or secondary UE 10B and/or one or more applications running on primary UE 10A and/or secondary UE 10B without user input) and/or may occur upon receipt of a user input provided to primary UE 10A and/or secondary UE 10B.

As examples, the second trigger condition may occur if/when secondary UE 10B becomes paired with primary UE 10A, if/when secondary UE 10B has moved less than a threshold distance R from primary UE 10A, if/when an object or obstacle no longer blocks P2P signals 21 between primary UE 10A and secondary UE 10B, if/when radio-frequency propagation or channel conditions between primary UE 10A and secondary UE 10B have risen above a threshold level, if/when wireless performance metric data gathered by UE 10A and/or UE 10B from P2P signals 21 has risen above a threshold level, if/when a satellite receiver on secondary UE 10B has identified that secondary UE 10B has left a predetermined location or moved to a predetermined location, if/when sensor data gathered by secondary UE 10B has a particular value (e.g., indicating that UE 10B is pairable with primary UE 10A), if/when it is a particular time of day and/or day of the week, if/when the user has provided a user input (e.g., via the display 39 (FIG. 2) on secondary UE 10B and/or primary UE 10A) that instructs one or more software applications and/or the operating system on one or both devices to perform the switch, if/when sensor data indicates that secondary UE 10B has been picked up or moved towards primary UE 10A, etc.

As another example, when primary UE 10A and/or secondary UE 10B gathers sensor data and/or wireless performance metric data indicative of the user walking back to or towards primary UE 10A with secondary UE 10B, one or more software applications on primary UE 10A and/or secondary UE 10B may issue an alert or notification on the display 39 (FIG. 2) informing the user of the switch and/or requesting that the user provide a user input to confirm the switch. The user may, for example, press an on-screen button, perform a gesture, and/or provide any other desired input to confirm a switch, upon which the UE devices will have determined that the trigger condition has occurred. If desired, one or more specific actions of the secondary UE, such as triggering the start of a run or hike, may implicitly indicate or trigger a transfer of the services to the secondary device. If desired, primary UE 10A and/or secondary UE 10B may perform hysteresis and/or slope detection on the gathered sensor data and/or wireless performance metric data to eliminate false positive triggers (e.g., to prevent the switch from occurring when secondary UE 10B has not moved to a location within P2P range of primary UE 10A). Once the second trigger condition has occurred, processing may proceed to operation 80.

If desired, transitioning out of specific known geofences such as leaving a home or office location with secondary UE 10B while simultaneously not being in proximity to primary UE 10A may be used to trigger the transition of the service to secondary UE 10B. Similarly, re-entering the geofence while simultaneously detecting the secondary UE in proximity of the primary UE may be used to trigger the transition of the service back to primary UE 10A. The geofence may be learned on device(s) by determining the user's frequented activities and/or other methods such as the use of a maps application and/or a contacts application, as examples.

At operation 80, primary UE 10A may re-attach, connect, or register to cellular network 22 and call routing server 14 using MSISDN (A). Secondary UE 10B may detach, disconnect, or deregister from call routing server 14 and cellular network 22. Primary device 10A may then convey wireless data with host(s) 18 using cellular signals 16A, cellular network 22, call routing server 14, and MSISDN (A). At the same time, secondary UE 10B is not attached or registered to either cellular network 22 or call routing server 14 using MSISDN (A). As such, call routing server 14 and cellular network 22 do not forward any wireless data associated with or destined for MSISDN (A) to secondary UE 10B. Secondary UE 10B does not transmit cellular signals 16B to cellular network 22. Cellular network 22 does not transmit paging signals, connected resources, access signals, or other cellular signals 16B to secondary UE 10B, and secondary UE 10B does not receive paging signals, connected resources, access signals, or other cellular signals 16B from cellular network 22. This may also serve to minimize power and resource consumption on secondary UE 10B. Processing may then loop back to operation 62 via path 81. Application service may be transferred back to primary UE 10A (e.g., one or more of the transfers at operation 76 may be reversed).

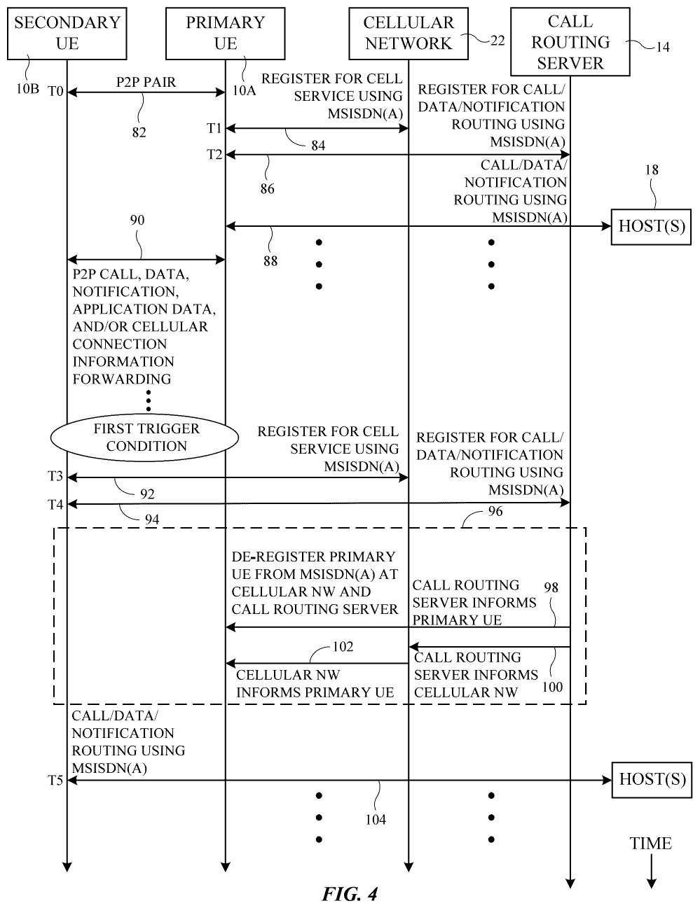

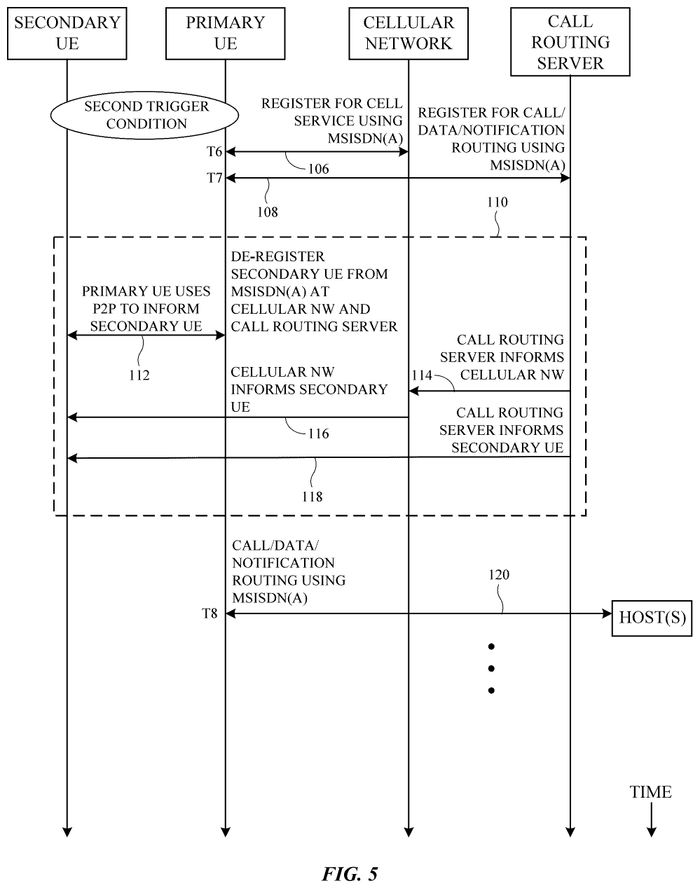

FIGS. 4 and 5 are timing diagrams showing how signals may be conveyed between secondary UE 10B, primary UE 10A, cellular network 22, call routing server 14, and host(s) 18 using the single MSISDN (A) shared between primary UE 10A and secondary UE 10B. As shown in FIG. 4, at time T0, secondary UE 10B may be paired to primary UE 10A using signals 82 (e.g., P2P signals 21 of FIG. 1).

At time T1 after T0, primary UE 10A may convey signals 84 (e.g., cellular signals 16A of FIG. 1) with cellular network 22 to register for cellular service using MSISDN (A) (e.g., while processing operation 60 of FIG. 3).

At time T2 after T1, primary UE 10A may convey signals 86 with call routing server 14 to register for call, data, and/or notification routing using MSISDN (A) (e.g., while processing operation 60 of FIG. 3). Signals 86 may include cellular signals 16A between primary UE 10A and cellular network 22. Signals 86 may also be routed between cellular network 22 and call routing server 14.

Beginning after time T2, call routing server 14 may begin to perform call, data, and/or notification routing between one or more hosts 18 and primary UE 10A using MSISDN (A). This may involve routing or forwarding wireless data 88 between host(s) 18 and primary UE 10A via cellular network 22. Wireless data 88 may be conveyed between cellular network 22 and primary UE 10A using cellular signals 16A.

Beginning after time T2 (e.g., while processing operation 62 of FIG. 3), primary UE 10A and secondary UE 10B may begin using P2P signals 21 to convey wireless data 90 between primary UE 10A and secondary UE 10B (e.g., for performing call, data, notification, application data, and/or cellular connection information forwarding between primary UE 10A and secondary UE 10B). Wireless data 90 may include wireless data transmitted by secondary UE 10B to primary UE 10A for transmission to host(s) 18 in wireless data 88, may include wireless data received by primary UE 10A in wireless data 88 and forwarded by primary UE 10A to secondary UE 10B in P2P signals 21, may include application data conveyed between secondary UE 10B and primary UE 10A, and/or may include cellular connection information transmitted by primary UE 10A to secondary UE 10B in P2P signals 21, as examples.

After the first trigger condition has occurred (e.g., while processing operation 68 of FIG. 3), at time T3, secondary UE 10B may convey signals 92 (e.g., cellular signals 16B of FIG. 1) with cellular network 22 to register for cellular service using MSISDN (A) (e.g., while processing operation 70 of FIG. 3).

At time T4 after T3, secondary UE 10B may convey signals 94 with call routing server 14 to register for call, data, and/or notification routing using MSISDN (A) (e.g., while processing operation 70 of FIG. 3). Signals 94 may include cellular signals 16B between secondary UE 10B and cellular network 22. Signals 94 may also be routed between cellular network 22 and call routing server 14.

At block 96 after time T4, primary UE 10A may deregister from communications with cellular network 22 and call routing server 14 using MSISDN (A) (e.g., while processing operation 72 of FIG. 3). This may, for example, involve call routing server 14 transmitting signals 98 to primary UE 10A to inform primary UE 10A and/or may involve call routing server 14 transmitting signals 100 to cellular network 22 to inform cellular network 22 that secondary UE 10B has taken over cellular communications using MSISDN (A) (e.g., in response to or after secondary UE 10B has registered with call routing server 14). If desired, cellular network 22 may transmit signals 102 (e.g., cellular signals 16A) to inform primary UE 10A that secondary UE 10B has taken over cellular communications using MSISDN (A) (e.g., in response to or after secondary UE 10B has registered with cellular network 22 and/or in response to call routing server 14 informing cellular network 22 that secondary UE 10B has taken over cellular communications using MSISDN (A)). Alternatively, cellular network 22 may forego informing primary UE 10A and may instead connect to and communicate with only the most-recently registered UE device using MSISDN (A).

Beginning at time T5, call routing server 14 may begin to perform call, data, and/or notification routing between one or more hosts 18 and secondary UE 10B using MSISDN (A) (e.g., while processing operation 74 of FIG. 3). This may involve routing or forwarding wireless data 88 between host(s) 18 and secondary UE 10B via cellular network 22. Wireless data 104 may be conveyed between cellular network 22 and secondary UE 10B using cellular signals 16B.

As shown in FIG. 5, after the second trigger condition has occurred (e.g., while processing operation 78 of FIG. 3), at time T6, primary UE 10A may convey signals 106 (e.g., cellular signals 16A of FIG. 1) with cellular network 22 to re-register for cellular service using MSISDN (A) (e.g., while processing operation 80 of FIG. 3).

At time T7 after T6, primary UE 10A may convey signals 108 with call routing server 14 to re-register for call, data, and/or notification routing using MSISDN (A) (e.g., while processing operation 80 of FIG. 3). Signals 108 may include cellular signals 16A between primary UE 10A and cellular network 22. Signals 108 may also be routed between cellular network 22 and call routing server 14.

At block 110 after time T7, secondary UE 10B may deregister from communications with cellular network 22 and call routing server 14 using MSISDN (A) (e.g., while processing operation 80 of FIG. 3). This may, for example, involve call routing server 14 transmitting signals 118 to secondary UE 10B to inform secondary UE 10B and/or may involve call routing server 14 transmitting signals 114 to cellular network 22 to inform cellular network 22 that primary UE 10A has taken over cellular communications using MSISDN (A) (e.g., in response to or after primary UE 10A has re-registered with call routing server 14). If desired, cellular network 22 may transmit signals 116 (e.g., cellular signals 16B) to inform secondary UE 10B that primary UE 10A has taken over cellular communications using MSISDN (A) (e.g., in response to or after primary UE 10A has registered with cellular network 22 and/or in response to call routing server 14 informing cellular network 22 that primary UE 10A has taken over cellular communications using MSISDN (A)). Alternatively, cellular network 22 may forego informing secondary UE 10B and may instead connect to and communicate with only the most-recently registered UE device using MSISDN (A). Additionally, or alternatively, primary UE 10A may use signals 112 (e.g., P2P signals 21) to inform secondary UE 10B that primary UE 10A has taken over cellular communications using MSISDN (A).

Beginning at time T8, call routing server 14 may begin to perform call, data, and/or notification routing between one or more hosts 18 and primary UE 10A using MSISDN (A). This may involve routing or forwarding wireless data 120 between host(s) 18 and primary UE 10A via cellular network 22. Wireless data 120 may be conveyed between cellular network 22 and primary UE 10A using cellular signals 16A.

In this way, the active device using MSISDN (A) may seamlessly transition over time, supporting automated priority detection and/or manually switching by the user. The active device switching described herein may also minimize the communications overhead of cellular network 22, since the network only needs to communicate with one of primary UE 10A or secondary UE 10B at a given time. The examples described above illustrate a simplest case in which set 8 includes only a single secondary UE 10B. If desired, set 8 may include multiple secondary UE devices. This may also be generalized to any desired number of shared MSISDN's belonging to a given user. If desired, primary UE 10A may have a first MSISDN (e.g., MSISDN (A)) whereas secondary UE has a second MSISDN (e.g., MSISDN (B)) that is different from the MSISDN, where both devices are still owned by the same user. In these examples, the user may have a subscription with the cellular network that supports only one of the first MSISDN or the second MSISDN being active (pageable by the cellular network) at a given time. In these examples, any of the communications described herein as being performed by the secondary UE with the cellular network using MSISDN (A) are equivalently performed using the second MSISDN (e.g., MSISDN (B)).

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

As described above, one aspect of the present technology is the gathering and use of information such as user input, application data, and/or sensor information. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, eyeglasses prescription, username, password, biometric information, or any other identifying or personal information.

The present disclosure recognizes that the use of such personal information, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the United States, collection of or access to certain health data may be governed by federal and/or state laws, such as the Health Insurance Portability and Accountability Act (HIPAA), whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to provide certain types of user data. In yet another example, users can select to limit the length of time user-specific data is maintained. In addition to providing “opt in” and “opt out” options, the present disclosure contemplates providing notifications relating to the access or use of personal information. For instance, a user may be notified upon downloading an application (“app”) that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

For one or more aspects, at least one of the components set forth in one or more of the preceding figures may be configured to perform one or more operations, techniques, processes, or methods as set forth herein. For example, the control circuitry as described above in connection with one or more of the preceding figures may be configured to operate in accordance with one or more of the examples set forth herein. For another example, circuitry associated with a UE, satellite, gateway, core network, base station, network element, etc. as described above in connection with one or more of the preceding figures may be configured to operate in accordance with one or more of the examples set forth herein.

An apparatus (e.g., an electronic user equipment device, a wireless base station, etc.) may be provided that includes means to perform one or more elements of a method described in or related to any of the methods or processes described herein.

One or more non-transitory computer-readable media comprising instructions to cause an electronic device, upon execution of the instructions by one or more processors of the electronic device, to perform one or more elements of any method or process described herein.

An apparatus comprising logic, modules, or circuitry to perform one or more elements of a method described in or related to any of the method or process described herein.

An apparatus comprising: one or more processors and one or more non-transitory computer-readable storage media comprising instructions that, when executed by the one or more processors, cause the one or more processors to perform the method, techniques, or process as described herein.

A signal, datagram, information element, packet, frame, segment, PDU, or message or datagram may be provided as described in or related to any of the examples described herein.

A signal encoded with data, a datagram, IE, packet, frame, segment, PDU, or message may be provided as described in or related to any of the examples described herein.

An electromagnetic signal may be provided carrying computer-readable instructions, wherein execution of the computer-readable instructions by one or more processors is to cause the one or more processors to perform the method, techniques, or process as described in or related to any of the examples described herein.

A computer program comprising instructions, wherein execution of the program by a processing element is to cause the processing element to carry out the method, techniques, or process as described in or related to any of the examples described herein.

A signal in a wireless network as shown and described herein may be provided.

A method of communicating in a wireless network as shown and described herein may be provided.

A system for providing wireless communication as shown and described herein may be provided.

A device for providing wireless communication as shown and described herein may be provided.

Any of the above-described examples may be combined with any other example (or combination of examples), unless explicitly stated otherwise. The foregoing description of one or more implementations provides illustration and description but is not intended to be exhaustive or to limit the scope of aspects to the precise form disclosed.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing is merely illustrative and various modifications can be made to the described embodiments. The foregoing embodiments may be implemented individually or in any combination.

What is claimed is:

1. An electronic device comprising:
one or more antennas;
a subscriber identity module (SIM) that identifies a Mobile Station International Subscriber Directory Number (MSISDN);
a first radio communicatively coupled to the one or more antennas, the first radio being configured to convey peer-to-peer (P2P) signals with an additional electronic device that is configured to convey first radio-frequency signals with a cellular network using the MSISDN; and
a second radio communicatively coupled to the one or more antennas, the second radio being configured to convey, using the MSISDN, second radio-frequency signals with the cellular network while the additional electronic device is deregistered from the cellular network.

2. The electronic device of claim 1, wherein the second radio is configured to register with the cellular network using the MSISDN after the first radio conveys the P2P signals and prior to the additional electronic device being deregistered from the cellular network.

3. The electronic device of claim 2, wherein the second radio is configured to register with a call routing server using the MSISDN after registering with the cellular network using the MSISDN and prior to the additional electronic device being deregistered from the cellular network.

4. The electronic device of claim 3, wherein the second radio is configured to deregister from the call routing server and the cellular network responsive to receipt, from the cellular network or the call routing server, of a signal identifying that the additional electronic device has taken over use of the MSISDN for communicating with the cellular network.

5. The electronic device of claim 2, wherein the second radio is configured to register with the cellular network responsive to wireless performance metric data associated with the P2P signals dropping below a threshold level.

6. The electronic device of claim 5, further comprising:
a display configured to display a confirmation request responsive to the wireless performance metric data associated with the P2P signals dropping below the threshold level.

7. The electronic device of claim 2, further comprising:
a touch screen display, wherein the second radio is configured to register with the cellular network responsive to an input received by the touch screen display.

8. The electronic device of claim 2, further comprising:
a sensor configured to generate sensor data, wherein the second radio is configured to register with the cellular network responsive to the sensor data being indicative of the electronic device moving away from the additional electronic device.

9. The electronic device of claim 8, wherein the second radio is configured to deregister from the cellular network responsive to the sensor data being indicative of the electronic device being in proximity to the additional electronic device.

10. The electronic device of claim 2, wherein the first radio is configured to receive, from the additional electronic device in the P2P signals, camping information associated with the cellular network, the second radio being configured to register with the cellular network using the camping information.

11. The electronic device of claim 1, wherein the electronic device comprises a wearable device, the additional electronic device comprises a cellular telephone, and the P2P signals comprise Bluetooth signals or wireless local area network (WLAN) signals.

12. The electronic device of claim 1, wherein the first radio is configured to transmit, in the P2P signals, wireless data that is transmitted by the additional electronic device to the cellular network in the first radio-frequency signals.

13. The electronic device of claim 1, wherein the first radio is configured to convey the P2P signals with the additional electronic device concurrent with the additional electronic device conveying the first radio-frequency signals with the cellular network.

14. A method of operating a first electronic device and a second electronic device to communicate with a cellular network, the method comprising:
conveying, using a first radio on the first electronic device, first wireless data with the cellular network while the second electronic device is in proximity to the first electronic device, the first wireless data being conveyed using a Mobile Station International Subscriber Directory Number (MSISDN);
attaching, using a second radio on the second electronic device, to the cellular network using the MSISDN responsive to a trigger condition associated with the second electronic device moving out of proximity to the first electronic device; and
conveying, using the second radio on the second electronic device, second wireless data while attached to the cellular network using the MSISDN.

15. The method of claim 14, further comprising:
detaching, using the first radio on the first electronic device, from the cellular network using the MSISDN after the second radio has attached to the second cellular network using the MSISDN and prior to the second radio conveying the second wireless data.

16. The method of claim 15, wherein detaching from the cellular network comprises:
receiving, using the first radio on the first electronic device, a signal from the cellular network indicative of the second electronic device having attached to the cellular network using the MSISDN.

17. The method of claim 15, wherein detaching from the cellular network comprises:
receiving, using the first radio on the first electronic device, a signal from a call routing server, the signal being indicative of the second electronic device having attached to the cellular network using the MSISDN.

18. The method of claim 14, further comprising:
detaching, using the second radio on the second electronic device, from the cellular network using the MSISDN in response to an additional trigger condition associated with the second electronic device moving back into proximity to the first electronic device.

19. A method of operating a call routing server, the method comprising:
forwarding, at a first time, first wireless data between one or more hosts and a first user equipment device that is attached to a cellular network using a Mobile Station International Subscriber Directory Number (MSISDN);
registering, at a second time after the first time, a second user equipment device that is attached to the cellular network using the MSISDN;
deregistering the first user equipment device from the MSISDN after registering the second user equipment device; and
forwarding, at a third time after the second time, second wireless data between the one or more hosts and the second user equipment device while the second user equipment device attached to the cellular network using the MSISDN and while the first user equipment device is deregistered from the MSISDN.

20. The method of claim 19, further comprising:
transmitting, to the first user equipment device after the second time, a signal that identifies that the second user equipment device has taken over communication with the cellular network using the MSISDN.
